(19) United States
(12) Patent Application Publication
(10) Pub. No.: US 2004/0065116 A1
(43) Pub. Date: Apr. 8, 2004

(54) Device and method for producing a syringe for medical purposes

(76) Inventors: Udo J. Vetter, Ravensburg (DE); Dieter H. Baumann, Oberteuringen (DE); Jens Bliedtner, Jena (DE)

Correspondence Address: OSTROLENK FABER GERB & SOFFEN, 1180 AVENUE OF THE AMERICAS, NEW YORK, NY, 100368403

(21) Appl. No.: 10/468,497

(22) PCT Filed: Jan. 25, 2002
(86) PCT No.: PCT/EP02/00840

(30) Foreign Application Priority Data
Feb. 19, 2001 (DE) 101 08 958.9

(51) Int. Cl. C03C 27/02

(52) U.S. Cl. 65/29.19; 148/206; 65/162; 65/155; 65/32.2

(57) ABSTRACT

An apparatus is proposed for manufacturing a syringe, which has a syringe body composed of glass and a hollow needle, for medical purposes, and is characterized by a laser beam generating device (3) having a laser generator (5) for producing a laser beam (9), a beam forming and/or guidance device (7), and by a holding device (17) for holding and positioning the syringe body (13).

### DESCRIPTION

The invention relates to an apparatus for manufacturing a syringe for medical purposes as claimed in the precharacterizing clause of claim 1, and to a method for manufacturing a syringe for medical purposes as claimed in the precharacterizing clause of claim 12.

Apparatuses and methods of the type under discussion here are known. They are known for the purpose of firmly connecting the hollow needles to the base body of syringes. Ready-to-use syringes which are produced in this way form the majority of the primary packing means which are used for parental application of items to be injected. They have a glass cylinder, which is referred to here as a syringe body, is rolled out on one side to form a cone which holds the hollow needle, and is rolled out on the other side to form a special rolled edge.

A hollow needle, which is preferably composed of stainless steel, is bonded firmly by means of UV-sensitive adhesive into the opening, which has a cone, in the glass cylinder. A hollow needle protective cap is generally placed over the hollow needle and is composed of an elastomer, preferably a natural rubber that is free of latex. The hollow needle protective cap is in this case clamped firmly onto the glass cone when it is fitted. The syringe cylinder is filled from the end opposite the hollow needle and is then closed by a piston plug, which is preferably provided with a thread. A plastic finger rest is attached to the glass cylinder by means of the rear rolled edge of the glass cylinder.

The adhesive bonding of the hollow needle to the glass cylinder results in a number of significant disadvantages: occasionally, the adhesive bonding is inadequate, for example because too little adhesive has been introduced into the joint gap between the cone and the hollow needle. This means that, once the adhesive has cured, the hollow needle is not fixed adequately and can be pulled out of the cone again. It is also possible for too much adhesive to be introduced into the joint gap. This results in the excess adhesive running away in the joint gap and, finally, flowing into the proximal end of the interior of the hollow needle. This can lead to the hollow needle becoming completely blocked. The fact that the hollow needle is blocked is frequently not evident until an attempt is made to inject the filling that is in the syringe.

Syringes are generally subjected to an autoclaving process, that is to say to a steam sterilization process, in order to kill any bacteria. This process is carried out in an autoclave for a time period of about 20 to 60 minutes at a temperature of 121° C., and with a pressure of 1.10 bar in the autoclave, depending on the product that is introduced into the syringe cylinder. 100% freedom from pyrogens in the syringe system can be achieved, however, only when the ready-to-use syringe is subjected to burning-in siliconization. For this purpose, the inner surface of the syringe body is provided with silicone and the syringe is passed through a hot air terminal which, for example, is operated at a temperature of about 340° C. However, this method step cannot be carried out with conventional UV-curing adhesives which are licensed for pharmaceutical purposes, since they are heat-resistant only up to a maximum temperature of about 150° C. At a higher temperature, they lose the strength that they were given during the curing process.

Furthermore, EP 0 794 031 A2 discloses a method and an apparatus for carrying out the method for processing workpieces made of glass, using which these workpieces can be separated, drilled and shaped and/or can have material removed.

The object of the invention is therefore to provide methods and means for manufacturing a syringe for medical purposes, by means of which it is possible to produce syringes which can be subjected to burning-in siliconization without this leading to any adverse effect on the attachment between the hollow needle and the syringe body composed of glass.

In order to achieve this object, the invention proposes the use of an apparatus for connecting the hollow needle to the syringe body, this apparatus having the features stated in claim 1, and in which the metal hollow needle is connected to the glass syringe body by means of the laser beam. The use according to the invention on the apparatus has the advantage that the process of producing the joint between the hollow needle and the syringe body can be carried out without using auxiliary substances such as adhesives which have little resistance to temperature. This syringe which can be produced with the aid of the apparatus is thus resistant to high temperatures and can therefore be subjected to burning-in siliconization. The apparatus also has a beam forming and/or guidance device. This is used to aim the laser beam at the joint zone between the syringe body and the hollow needle and, if required, to match the beam geometry to a desired melting process. Finally, the apparatus has a holding device for holding and positioning the syringe body.

Further refinements can be found in the other dependent claims.

In order to achieve this object, a method of the type mentioned initially is also proposed, which has the steps stated in claim 12 and is distinguished in that the material of the syringe body is preheated at a first temperature and is melted at a second temperature in the area of the joint zone, and in that the material of the syringe body is subsequently heated at a third temperature in the area of the joint zone.

Further embodiments of the method can be found in the dependent claims.

The invention will be explained in more detail in the following text with reference to the drawing, in which:

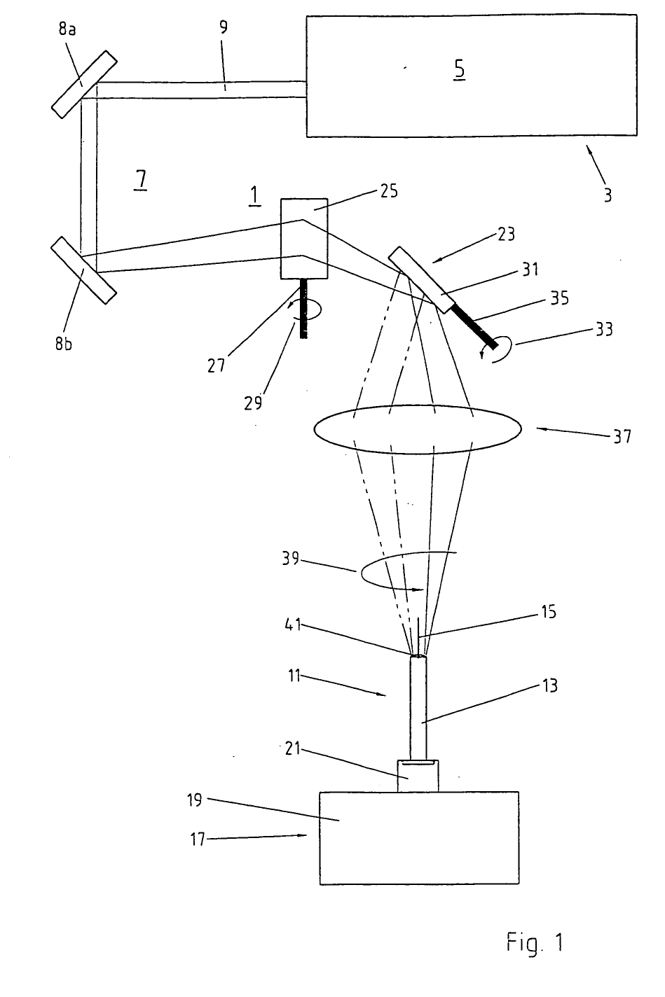

FIG. 1 shows an apparatus for manufacturing a syringe for medical purposes having a syringe, which is arranged such that it is stationary, and a moving laser beam;

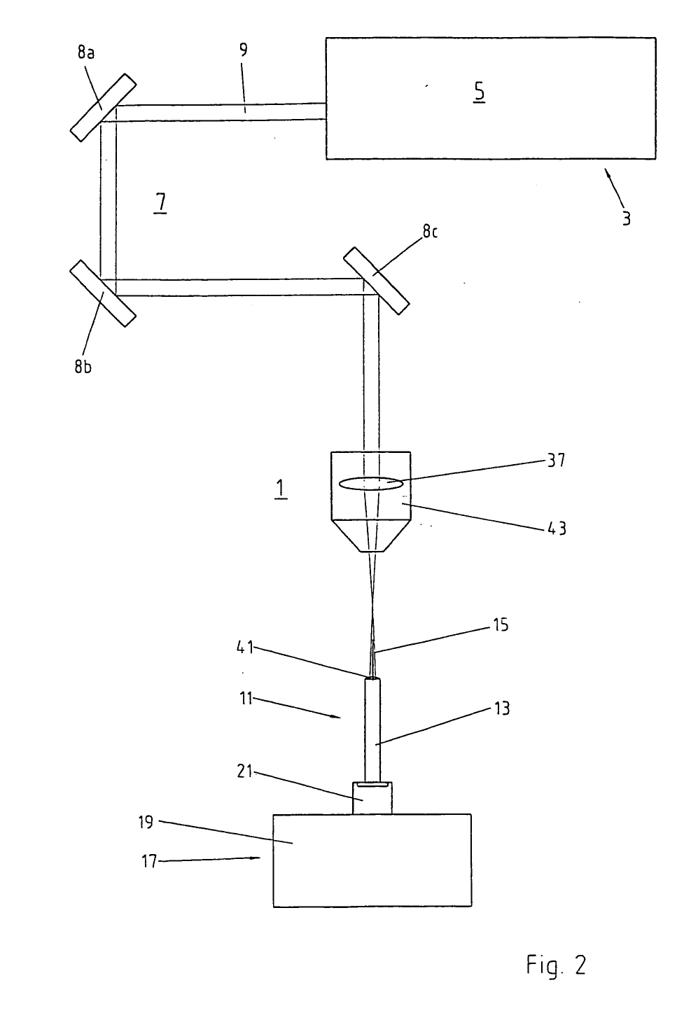

FIG. 2 shows an apparatus for manufacturing a syringe for medical purposes having a syringe, which is arranged such that it is stationary, and a fixed laser beam;

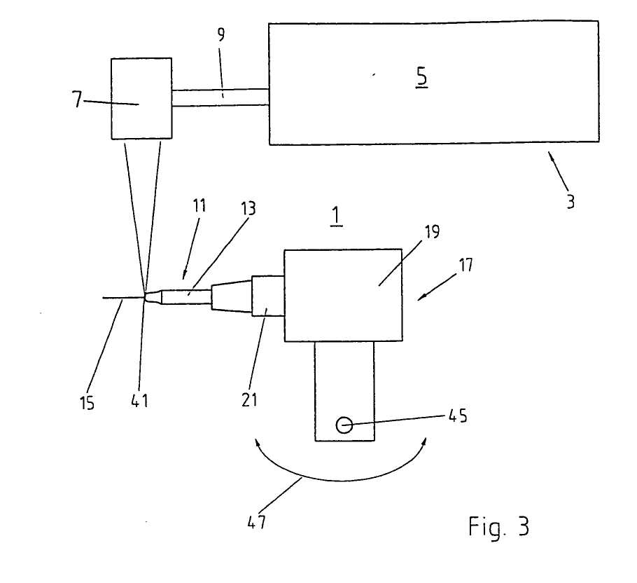

FIG. 3 shows an apparatus for manufacturing a syringe for medical purposes having a rotating syringe and a fixed laser beam;

FIG. 4 shows a graph illustrating the fundamental temperature profile during the process of manufacturing a syringe, plotted against time;

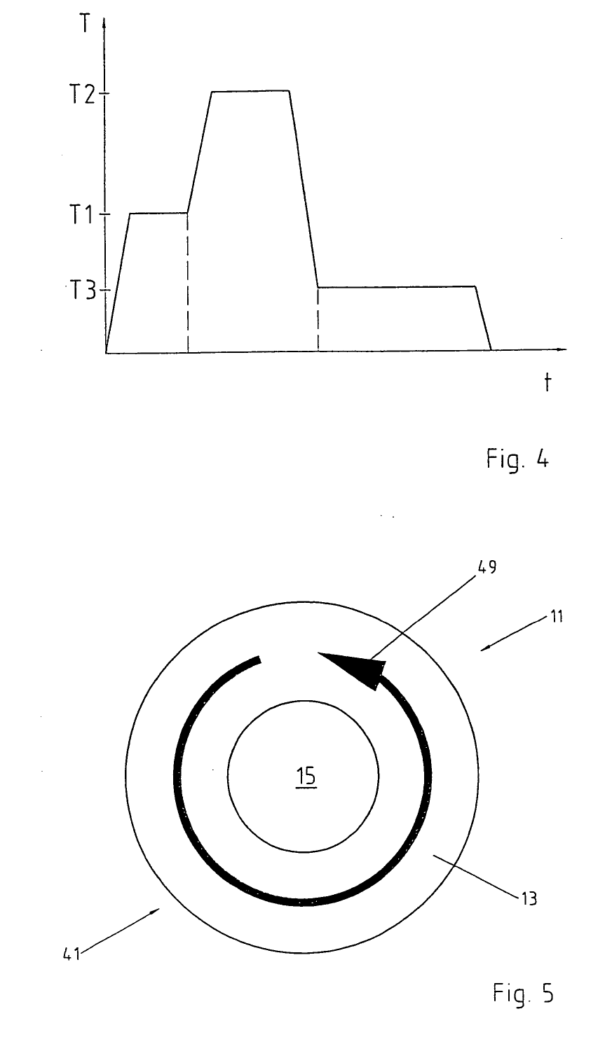

FIG. 5 shows an outline sketch to illustrate the movement path of the laser beam during the process of manufacturing a syringe for medical purposes;

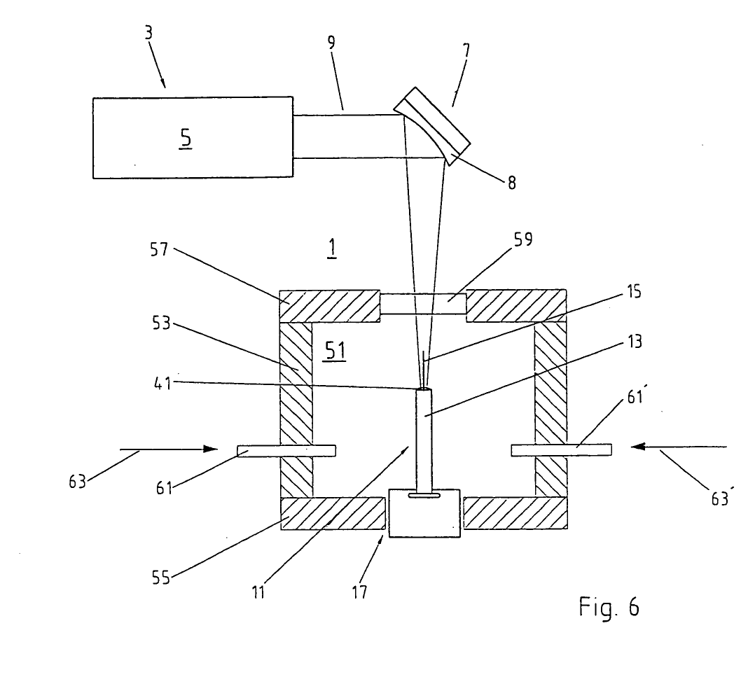

FIG. 6 shows an apparatus for manufacturing a syringe for medical purposes, having a syringe which is arranged such that it is stationary and having a stationary laser beam;

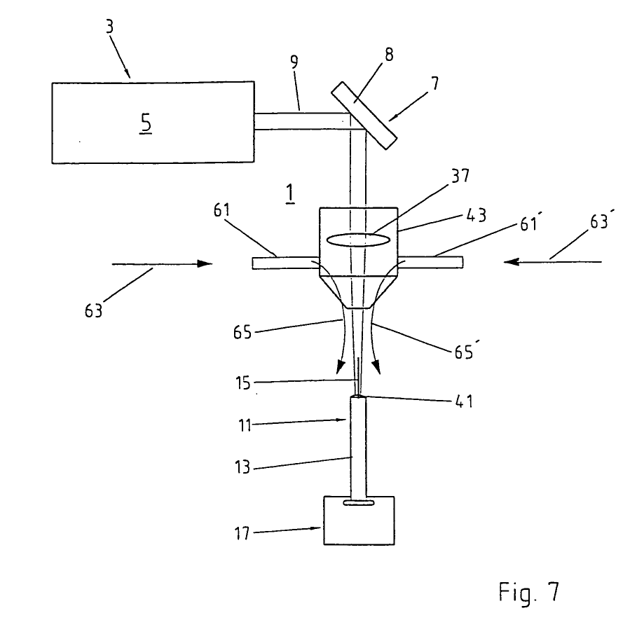

FIG. 7 shows a further apparatus for manufacturing a syringe for medical purposes, having a stationary syringe and a fixed laser beam; and

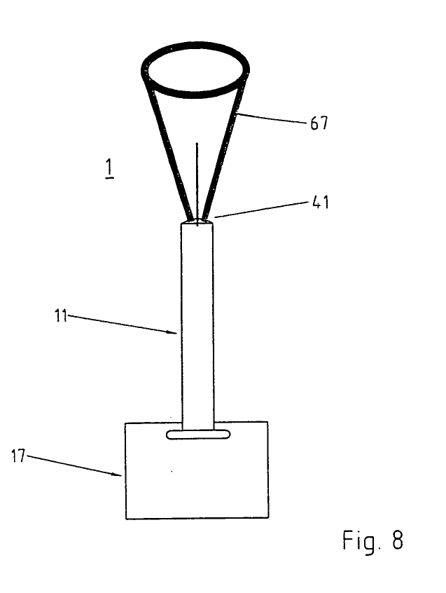

FIG. 8 shows an illustration of the stationary heating with annular distribution of the laser beam.

FIG. 1 shows a first exemplary embodiment of an apparatus for manufacturing a syringe for medical purposes. The apparatus 1 has a laser beam generating device 3, whose basic design is in principle known and which has a laser resonator with an appropriate supply unit. The device is referred to for short in the following text as a laser resonator 5. The apparatus 1 also has a beam guidance device 7 with mirrors 8a and 8b which is used in the end to aim the laser beam 9, which is produced by the laser resonator 5, at a syringe 11, which has a syringe body 13 and a hollow needle 15. The syringe 11 is held by a suitable holding device 17, which has a positioning device 19 and a holding mandrel 21 for holding the syringe body 13.

The beam guidance device 7 has a scanner device 23 with two moving mirrors. A first scanner mirror 25 can rotate about a first rotation axis 27, as is indicated by an arrow 29. A second scanner mirror 31 of the scanner device is arranged inclined through 450 with respect to the first scanner mirror 25 and, as indicated by an arrow 33, can swivel about a second rotation axis 35. The rotation axes 27 and 35 are connected to suitable drive devices, which are not shown here but which produce a deliberate swiveling movement of the scanner mirrors 25 and 31. The first scanner mirror 25 is used, for example, to move the laser beam 9 in a first direction, for example the x direction, while the second scanner mirror 31 is used to move the laser beam 9 in a second direction, for example the y direction, that is to say at right angles to the first direction.

Seen in the direction of the laser beam 9 which originates from the laser resonator 5, the scanner device 23 is followed by a focusing unit 37, which is used to focus the laser beam 9 on the joint zone between the hollow needle 15 and the syringe body 13. An arrow 39 indicates that the x-y movement of the laser beam 9 is produced by the scanner device 23 such that the laser beam 9 follows a circular path here, in order to paint the joint zone 41. The scanner device 23 is designed such that the laser beam 9 can follow any desired contour.

The positioning device 19 of the holding device 17 is in this case designed such that the syringe 11 is held firmly in a desired position in order that the laser beam 9 can be applied to the joint zone 41 in a desired manner, with the beam being moved by the scanner device 23 and the laser beam 9 being focused by means of the focusing unit 37 onto the joint zone 41. In this case, the focusing device 37 can be used to influence the focus area, that is to say effectively the light spot which is produced by the laser beam 9 in the area of the joint zone 41. In the exemplary embodiment of the apparatus 1 as illustrated here, the focusing unit 37 has a planar field lens. The focusing unit 37 can thus be produced in a simple, low-cost manner.

In principle, it is also possible to design the holding device 17 such that the holding mandrel 21 is caused to rotate, so that the syringe 11 also rotates. This rotary movement may also be desirable for the movement of the laser beam 9 that is produced by the scanner device 23. It is also feasible for the scanner device 23 to be set such that the laser beam 9 is focused at a point or on an area of the joint zone 41, and such that the syringe 11 is then made to rotate in order, in the end, to aim the laser beam 9 at the entire joint zone 41. However, the apparatus 1 that is illustrated in FIG. 1 is based on the assumption that the syringe 11 is stationary and that the laser beam 9 carries out a movement in the area of the joint zone 41, with the aid of the scanner device.

FIG. 2 shows a modified form of an apparatus 1 for manufacturing a syringe for medical purposes. Identical parts are provided with the same reference numbers, so that reference is made to the above description relating to FIG. 1.

The apparatus 1 once again has a laser beam generating device 3 with the usual elements. This is referred to for short in the following text as the laser resonator 5. This uses a beam guidance device 7 to emit a laser beam 9 which is aimed at the syringe 11, in particular at the focusing zone 41. In this case as well, the syringe 11 has a syringe body 13 and a hollow needle 15, that is held by a holding device 17 having a positioning device 19 and a holding mandrel 21.

In addition to the two mirrors 8a and 8b already illustrated in FIG. 1, the beam guidance device 7 has a mirror 8c. The first two mirrors 8a and 8b are used to deflect the beam that emerges from the laser resonator 5 through 900 in each case, such that it strikes the third mirror 8c horizontally from the left, where it is deflected through 900, in order to strike the syringe 11 or the joint zone 41.

A processing head 43 is provided between the third mirror 8c and the joint zone 41, has a focusing unit 37 and is used to focus the laser beam 9 on the joint zone 41.

In the exemplary embodiment illustrated here, the processing head 43 is designed such that the laser beam 9 does not have any additional movement applied to it, as is the case with the scanner device 23 shown in FIG. 1. Provision is thus made for the apparatus 1 as shown in FIG. 2 for the holding device 17 to be designed such that the holding mandrel 21 is made to rotate. The stationary laser steel 9 which is aimed at the syringe 11 thus in the end paints the entire joint zone 41, and the size of the laser focus or laser spot which is produced by the laser beam 9 can be influenced by the focusing unit 37.

FIG. 3 shows a further exemplary embodiment of an apparatus 1. Identical parts are once again provided with the same reference numbers, so that reference is made to the description relating to the previous figures.

The apparatus 1 has a laser generating device 3 with a laser resonator 5 which emits a laser beam 9, which strikes a beam guidance device 7 and is aimed at a joint zone 41. A holding device 17 holds a syringe 11 with a syringe body 13 and a hollow needle 15. The holding device 17 has a positioning device 19 with a holding mandrel 21, which holds the syringe 11. The entire holding device 17 is mounted such that it can swivel about a swivel axis 45, as is indicated by an arrow 47.

While, in the previous exemplary embodiments, the laser beam 9 was aimed at the joint point 41 from the front, the laser beam 9 in the exemplary embodiment shown in FIG. 3 strikes the syringe 11 or its joint zone 41 at the side.

In the illustration shown in FIG. 3, the holding device 17 is arranged such that the syringe 11 is held horizontally, and this is also referred to as the 0° position.

The beam guidance device 7 is in this case designed, in the same way as in the case of the apparatuses 1 illustrated in the previous figures, such that the laser beam 9 is focused on the joint zone 41 and such that, furthermore, the shape of the laser focus in the area of the joint zone can be varied. It is thus possible to produce a round or oval laser spot here in the area of the joint zone. The laser beam 9 is not moved in the exemplary embodiment of the apparatus 1 that is illustrated in FIG. 3. Instead, the syringe 11 is rotated at a predetermined, desired speed of rotation, in order to apply the laser beam uniformly to the joint zone 41.

In the apparatus shown in FIG. 3, the syringe 11 can be swiveled to a greater or lesser extent away from the horizontal position, so that the laser beam is applied to the joint zone 41 further forward or not so far forward. Finally, it is also possible in this case to swivel the holding device 17 about the swivel axis 45 such that the syringe 11 runs vertically upwards, as is the case in the exemplary embodiments shown in FIGS. 1 and 2. Thus, if the beam guidance device 7 and the holding device 17 are positioned approximately, the laser beam can thus also be applied to the joint zone 41 from above or from the front. It is thus possible to use the holding device 17 as illustrated in FIG. 3 rather than the holding devices as illustrated in FIG. 1 and 2. Either a stationary laser beam or a moving laser beam can be used for this purpose.

The number of mirrors which are used in conjunction with the beam guidance device 7 depends on how it is intended to deflect the laser beam 9, and how the laser resonator 5 is aligned with respect to the syringe 11. It is thus possible to arrange the laser resonator 5 such that it effectively applies the laser beam directly to the joint zone 41. It would then be possible to directly introduce the scanner device 23 or the processing head 43 into the laser beam.

The operation of the apparatus and the method for manufacturing a syringe for medical purposes will be described in more detail in the following text:

The apparatus 1 is used to apply laser radiation to the joint zone 41, in order to melt the material of the syringe body 13 in order that it is permanently connected to the hollow needle 15 while the material is solidifying. The syringe 11 that is referred to here is generally a syringe body 13 composed of glass. A CO₂ laser is therefore used, owing to its absorption characteristics.

The laser beam generating device 3 is designed such that the timing of the energy in the laser beam can be controlled.

When manufacturing a syringe 11, the material of the syringe body 13 must be melted locally to a limited extent, specifically in the joint zone 41. In this case, the material in the area of the joint zone 41 is first of all heated slowly at a relatively low power level. This preheating phase is followed by the actual process of producing the connection between the syringe body 13 and the hollow needle 15. The material of the syringe body 13 is melted in the area of the joint zone such that it runs into the joint gap between the syringe body and the hollow needle, thus completely enclosing the hollow needle.

As the material of the syringe body 13 cools down, stresses can occur, which later result in a fracture. The power of the laser beam generating device 3 is thus preferably controlled such that the joint zone 41 is still heated for a certain time period afterwards. The temperature during this subsequent heating phase is considerably lower than during the connection process, and is also preferably less than that during the preheating phase.

The apparatuses 1 described here are designed such that the laser power, the geometry of the laser beam and the focus size and position can be adjusted during the process of manufacturing the syringe. In the apparatuses 1 which have been explained with reference to FIGS. 1 and 2, the focusing unit 37 can be designed such that, in this case as well, the geometry of the laser beam 9, that is to say the beam diameter and/or the shape of the laser spot which is produced in the joint zone 41, can be varied.

The material heating and the melt volume can be influenced on the one hand by the power control within the laser beam generating device 3 and, on the other hand, by the laser beam being passed at a greater or lesser speed over the joint zone 41. The speed can be matched to the given conditions by the speed of rotation of the syringe 11 or else, using the scanner device 23, by the movement of the laser beam 9.

The scanner device 23 can be designed such that the laser beam 9 can be applied with the desired timing to different areas of the joint zone 41, even if the syringe 11 is fixed.

The apparatus 1 in the method can be adjusted such that a desired temperature/time profile is produced in the area of the joint zone 41. Furthermore, the syringe body 13 can also be heated in adjacent areas, in order to decrease material stresses.

The temperature which is produced in the joint zone 41 can be detected and evaluated with the aid of a temperature detection unit, in order to drive the laser beam generating device 3 appropriately and in order to set the desired temperature or the desired temperature profile. Thermocameras and/or pyrometers or else any other temperature detection devices can be used as the temperature detection unit.

In order to prevent oxidation of the metal hollow needle 15, the method is carried out at least partially or entirely in an inert gas atmosphere.

Finally, additional materials (which are used as a connecting medium), in particular glass solder, can be introduced into the joint zone 41 during the manufacture of the syringe 11, on the one hand to close even relatively large joint gaps and on the other hand to ensure a low-stress connection between the hollow needle 15 and the syringe body 13, which have very different thermal coefficients of expansion.

The essential feature is that the method described here allows non-contacting manufacture of the syringe, without this requiring any adhesive. If the only materials in the joint zone 41 are glass and metal, then there are no problems in subjecting the finished syringe 11 to burning-in siliconization and in introducing it into a hot air tunnel in which the temperatures are also in the region of 340° C.

The connection between the syringe body 13 and the hollow needle 15 can be produced very quickly if the energy content of the laser beam 9 is appropriate. The simple configuration of the apparatuses 1 described in the figures also allows the process of manufacturing the syringe to be automated, and the syringe to be produced at low cost with short unit production times.

The connection between the syringe body 13 and the hollow needle 15 is distinguished by being very firm, thus ensuring reliable use of the syringe 11. It is also distinguished by unrestricted, unchanging resistance to aging. Finally, the method resorts in an excellent low scrap rate.

The way in which the method is carried out will be explained in principle once again with reference to FIG. 4: the figure shows the temperature T produced in the joint zone 41, plotted against the time t. As can be seen, the joint zone 41 is initially preheated. A preheating temperature is maintained over a certain time period. Then, in a second time period, the laser beam generating device 3 is driven appropriately to produce a higher temperature in the area of the joint zone 41, in order to ensure the actual connection between the syringe body 13 and the hollow needle 15. The joint zone 41 is then allowed to cool down, before being held at a temperature below the melting temperature in order to dissipate stresses. The subsequent heating phase may be considerably longer than the preheating phase and connection phase; in this case, the subsequent heating temperature may also be less than the preheating temperature.

A number of numerical values relating to the graph illustrated in FIG. 4 will be introduced in the following text. The preheating temperature Tl is less than the transformation temperature TG of the respectively used glass, and is preferably 50 to 100 K below TG. The temperature T2 required for melting and for the joining process is higher than the transformation temperature TG, preferably about 50 to 100 K above this temperature.

The subsequent heating temperature T3 chosen in the subsequent heating phase is, for example, in a range from 150 to 300 K below the transformation temperature TG.

The temperature T1 is maintained, for example, for a time period of about two to three seconds, the temperature T2 which is chosen during the actual process of producing the connection between the syringe body 13 and the hollow needle 15 is maintained for about one to two seconds, and the subsequent heating temperature T3 is maintained for about three to five seconds. This is followed by the joint zone 41 being allowed to cool down in a more or less deliberate manner. The transformation temperature TG is, for example, about 565° C., depending on the glass that is used.

It can thus be seen from FIG. 4 that the temperature in the area of the joint zone 41 is controlled such that the magnitude of the temperature and the time for which the temperature acts are matched to the materials of the syringe and hollow needle.

FIG. 5 shows, purely schematically, a syringe 11 from the front, that is to say the joint zone 41. The syringe body 13 is illustrated as an outer ring and the hollow needle 15 is illustrated as an inner ring, although its interior is not shown here. The arrow 49 indicates the movement path of a light spot, which is formed by the laser beam 9, in the area of the joint zone 41. As can be seen, the light spot that is produced by the laser beam is moved along a circular path. This can be achieved by a fixed light spot with a rotating syringe 11, or by means of a scanner device 23 with a fixed syringe 11.

FIG. 6 also shows a further embodiment of an apparatus 1 which is used for manufacturing a syringe 11 for medical purposes. Parts which have already been described with reference to the previous figures are in this case provided with the same reference numbers, so that reference is made to the above description.

The apparatus 1 has a laser beam generating device 3 with a laser resonator 5 which emits a laser beam 9. This laser beam is passed via a beam guidance device 7 to the joint zone 41 between the hollow needle 15 and the syringe body 13 of the syringe 11. The essential feature here is that the syringe 11 is held by a holding device 17 such that it is stationary.

The laser beam device 7 is also designed to be stationary and has a fixed, concave mirror 8, which focuses the laser beam 9 onto the joint zone 41.

As has already been stated above, an inert gas can be used while manufacturing the syringe 11. Thus, in the exemplary embodiment described here, and as is also possible in the case of the exemplary embodiments described above, a chamber 51 is provided which is closed by walls 53, arranged all the way around, and by a base 55 as well as a cover 57. The cover is provided with an optical window 59 through which the laser beam 9 can pass and which allows the laser beam 9 to have free access to the joint zone 41. The window is produced from a special glass which does not cause any absorption and, by way of example, it is possible to use any type of quartz glass, in particular quartz glass composed of ZnBSe.

Inert gas is introduced in some suitable manner into the chamber 51. Two supply lines 61, 61′, by way of example, are provided here, which pass through the walls 53 and via which an inert gas is introduced, as indicated by arrows 63, 63′. When the laser beam 9 is applied to the joint zone 41, this ensures that the inert gas has forced the oxygen out of the atmosphere within the chamber 41, at least in this area.

In principle, it is possible to provide the holding device 17 with a drive as well, in order to make the syringe 11 rotate. However, the configuration is particularly simple if the syringe is arranged such that it is stationary, as described.

The exemplary embodiment of an apparatus 1 as illustrated in FIG. 7 for producing a syringe 11 likewise has a laser beam generating device with a laser resonator 5, which aims a laser beam 9 at a syringe 11 via a beam guidance device 7. The laser beam is aimed by means of a processing head 43 at the joint zone 41 between the hollow needle 15 and the syringe body 13. As explained with reference to FIG. 2, the processing head has a focusing unit 37 which has at least one lens. The processing head is, however, in this case also provided with supply lines 61, 61′ via which an inert gas, as illustrated by arrows 63, 63′, 65, 65′ is passed to the joint zone 41. When heat is applied to the joint zone 41, any oxygen which is present here is forced away by the inert gas so as to avoid oxidation, in particular of the metal hollow needle 15.

In the exemplary embodiment illustrated in FIG. 7, the path of the laser beam is simpler than that which has been explained with reference to FIG. 2. In this case, only a single mirror 8 is required in order to aim the laser beam 9, which emerges from the laser beam generating device 3, via the processing head 43 at the joint zone 41. The holding device 17, which holds the syringe 11, is once again in this case preferably designed such that the syringe is arranged to be stationary, while the laser beam 9 is applied to the joint zone 41. However, in principle, it is also feasible to provide a drive unit here, which makes the syringe 11 rotate.

In the exemplary embodiment described here, a laser beam 9 with an annular beam profile is preferably used. This can be produced on the one hand by using a special laser beam generating device, for example by a laser type which operates using TEM₀₁. On the other hand, however, it is also possible to use beam forming elements, for example shutters. These are preferably cooled.

If necessary, an annular beam profile can be produced by using the special laser type or by using shutters which are introduced into the beam path. In all cases, it is possible to cool the shutters, or else any mirrors or the like which may be introduced into the beam path.

FIG. 8 once again shows a part of an apparatus 1 for producing a syringe 11, which is held by a holding device 17. An annular distribution of the laser beam is indicated by an upside-down cone 67, whose syringe is located in the area of the joint zone 41, and this is used to heat the joint zone 41 uniformly even when the syringe 11 is stationary.

It should also be expressly noted here that all the explanatory notes relating to the exemplary embodiments of the apparatus 1 which have been explained with reference to FIGS. 1 to 5 also apply to those in the further FIGS. 6 and 7. Conversely, a chamber 51 can, of course, also be used for the exemplary embodiments explained with reference to FIGS. 1 to 5. Finally, the processing head which has been explained with reference to FIG. 2 can also be replaced, as has been described in conjunction with FIG. 7.

1. Use of an apparatus for manufacturing a syringe, which has a syringe body composed of glass and a metal hollow needle, for medical purposes, by having a laser generating device (3) for producing a laser beam (9), a beam forming and/or guidance device (7), and a holding device (17) for holding and positioning the syringe body (13) for connecting the hollow needle to the syringe body, with the metal hollow needle (15) being connected to the glass syringe body (13) by means of the laser beam (9).

2. Use of the apparatus as claimed in claim 1, characterized in that the holding device (17) holds the syringe body (13) such that it is stationary, and in that the beam forming and/or guidance device (7) produces a stationary laser beam with an annular and/or conical distribution.

3. Use of the apparatus as claimed in claim 1, characterized in that the holding device (17) has a holder, which can rotate and/or pivot, for the syringe body (13).

4. Use of the apparatus as claimed in one of the preceding claims, characterized in that the beam forming and/or guidance device (7) has at least one mirror (8a, 8b, 8c) and/or at least one shutter.

5. Use of the apparatus as claimed in one of the preceding claims, characterized in that at least one scanner mirror (25, 31) is mounted such that it can move.

6. Use of the apparatus as claimed in one of the preceding claims, characterized in that the beam forming and/or guidance device (7) has a drive apparatus for moving the at least one scanner mirror (25, 31).

7. Use of the apparatus as claimed in one of the preceding claims, characterized by a focusing unit (37).

8. Use of the apparatus as claimed in one of the preceding claims, characterized by a controller for influencing the power of the laser resonator (5).

9. Use of the apparatus as claimed in one of the preceding claims, characterized by a temperature detection unit.

10. Use of the apparatus as claimed in one of the preceding claims, characterized in that the laser beam generating device (3) has a CO₂ laser.

11. Use of the apparatus as claimed in one of the preceding claims, characterized in that at least the joint zone (41) between the syringe body (13) and the hollow needle (15) can have inert gas applied to it.

12. A method for manufacturing a syringe, which has a syringe body composed of glass and a metal hollow needle, for medical purposes for connecting the hollow needle to the syringe body of a syringe, having the following steps:
a laser beam (9) is applied to the joint zone (41) between the syringe body (13) and the hollow needle (15), with the material of the syringe body (13) in the area of the joint zone (41) being preheated by the laser beam at a first temperature and being partially melted by the laser beam at a second temperature, so that the molten material flows into the joint gap between the syringe body and the hollow needle, and with the material of the syringe body (13) in the area of the joint zone (41) being subsequently heated at a third temperature by means of the laser beam,
the molten material is cooled down.

13. The method as claimed in claim 12, characterized in that the laser beam (9) is stationary during the method process.

14. The method as claimed in claim 12, characterized in that the laser beam (9) is moved during the method process.

15. The method as claimed in one of claims 12 to 14, characterized in that the syringe body (13) or the syringe (11) is moved during the melting process.

16. The method as claimed in one of the preceding claims 12, 14 or 15, characterized in that the laser-beam (9) is moved in two directions.

17. The method as claimed in one of the preceding claims 12 to 16, characterized in that the beam geometry and/or the focusing area are/is changed.

18. The method as claimed in one of claims 12 to 17, characterized in that the temperature in the area of the joint zone (41) is controlled.

19. The method as claimed in one of the preceding claims 12 to 18, characterized in that the material of the syringe body (13) has the laser beam (9) applied to it as a function of time and/or temperature in the area of the joint zone (41).

20. The method as claimed in one of the preceding claims 11 to 19, characterized in that the melt volume in the area of the joint zone (41) is controlled.

21. The method as claimed in one of the preceding claims 12 to 20, characterized in that the syringe (11) or the syringe body (13) is moved, preferably rotated, during the melting process.

22. The method as claimed in one of the preceding claims 12 to 21, characterized in that the syringe (11) or the syringe body (13) is stationary during the melting process.

23. The method as claimed in one of the preceding claims 12 to 22, characterized in that additional materials are used as a connecting medium.

24. The method as claimed in one of the preceding claims 12 to 23, characterized in that an inert gas is used.
